(19) United States
(12) Patent Application Publication
(10) Pub. No.: US 2023/0387687 A1
(43) Pub. Date: Nov. 30, 2023

(54) CHECKING METHOD AND SYSTEM FOR MEDIUM-AND-LONG-TERM MAINTENANCE PLAN IN POWER GRID, AND DEVICE AND STORAGE MEDIUM

(71) Applicants: China Electric Power Research Institute, Beijing (CN); State Grid Shanxi Electric Power Research Institute, Taiyuan, Shanxi (CN)

(72) Inventors: Yuxuan LI, Beijing (CN); Chuancheng ZHANG, Beijing (CN); Sai DAI, Beijing (CN); Hui CUI, Beijing (CN); Qiang DING, Beijing (CN); Lixin LI, Beijing (CN); Qiang LI, Beijing (CN); Yi PAN, Beijing (CN); Zhi CAI, Beijing (CN); Yueshuang BAO, Taiyuan (CN); Xinyuan LIU, Taiyuan (CN); Huiping ZHENG, Taiyuan (CN); Wei HAN, Beijing (CN); Wei WANG, Beijing (CN); Lei WANG, Beijing (CN); Jinghua YAN, Beijing (CN); Bin HAN, Beijing (CN); Xiaojing HU, Beijing (CN); Bo LI, Beijing (CN); Guodong HUANG, Beijing (CN); Dan XU, Beijing (CN); Jiali ZHANG, Beijing (CN); Weigang LI, Beijing (CN)

(73) Assignees: China Electric Power Research Institute, Beijing (CN); State Grid Shanxi Electric Power Research Institute, Taiyuan, Shanxi (CN)

(21) Appl. No.: 18/250,983

(22) PCT Filed: Aug. 25, 2021
(86) PCT No.: PCT/CN2021/114530

§ 371 Date: Apr. 28, 2023

(30) Foreign Application Priority Data
Oct. 28, 2020 (CN) 202011174287.1

(51) Int. Cl. H02J 3/00

(52) U.S. Cl. CPC H02J 3/003; H02J 3/004

(57) ABSTRACT

A method for checking a medium-term and long-term maintenance plan of a power grid. A predicted load value and one or more historical load values of a power grid are acquired and clustered through a clustering algorithm, and a historical moment at which a historical load value is in a same cluster as the predicted load value and has a largest load value is selected as a target historical moment. A power grid operation mode model at the target historical moment is acquired, and the power grid operation mode model is updated according to the maintenance plan and open loop point information by using a full wiring approach to obtain a future-state power grid operation mode model. Ground state power flow data of the power grid are calculated based on the operation mode model, and safety check is carried out according to a preset ground state power flow limit.

### CROSS-REFERENCE TO RELATED APPLICATION

The disclosure is based on and claims priority to Chinese patent application No. 202011174287.1, filed on Oct. 28, 2020, the disclosure of which is hereby incorporated by reference in its entirety.

### TECHNICAL FIELD

The disclosure belongs to the field of dispatching and operation of power systems, and particularly relates to a method, system and device for checking a medium-term and long-term maintenance plan of a power grid and a storage medium.

### BACKGROUND

The formulation of a maintenance plan of power equipment is a necessary measure for improving the reliability of the equipment and elements of power systems, which is essential to the stable operation of a power grid. However, the maintenance time of a part of maintenance equipment is long, and a medium-term and long-term maintenance plan needs to be made. Meanwhile, in order to ensure safe and stable operation of the power grid, the safety of the maintenance plan needs to be checked when the maintenance plan is arranged, and then the maintenance plan is optimized to ensure normal maintenance.

With the development of the interconnected power grids and the deepening of intelligent substation construction, the workload of equipment commissioning and equipment transformation is greatly increased, so that the operation mode of the power grid is more complicated and changeable, and stricter requirements are imposed for the safety check work of the medium-term and long-term maintenance plan of the power grid. The safety check of the medium-term and long-term maintenance plan is an inevitable requirement for the optimal configuration of power resources and an important means for promoting lean management of dispatching, which can improve the capacity of a dispatching system for managing the large power grid, and improve the safety pre-control capacity of the dispatching and operation of the power grid.

For a long time, the check of the medium-term and long-term maintenance plan is mainly made according to manual experience, and relatively speaking, there is a lack of a quantitative safety check analyzing means. Meanwhile, under the condition of the medium-term and long-term maintenance plan, the problem of boundary data loss exists in the safety check of the power grid, such as unknown unit start-up mode, unknown unit output, uncertain operation mode of the power grid and the like, and meanwhile, the check based on manual experience leads to great difficulty and low accuracy of a check result.

### SUMMARY

Embodiments of the disclosure provide a method, system and device for checking a medium-term and long-term maintenance plan of a power grid and a storage medium, which can solve the problems of great difficulty and low accuracy of a check result of safety check of the medium-term and long-term maintenance plan.

In order to achieve the forgoing objective, the embodiments of the disclosure adopt the following technical solutions.

The embodiments of the disclosure provide a method for checking a medium-term and long-term maintenance plan of a power grid, which may include the following operations.

A predicted load value and one or more historical load values of a power grid are acquired.

The predicted load value and the historical load values are clustered through a clustering algorithm, and a historical moment at which a historical load value is in a same cluster as the predicted load value and has a largest load value among the historical load values is selected as a target historical moment.

A power grid operation mode model at the target historical moment is acquired, and the power grid operation mode model is updated according to the maintenance plan and open loop point information by using a full wiring approach to obtain a future-state power grid operation mode model.

Ground state power flow data of the power grid are calculated based on the future-state power grid operation mode model, and safety check on the medium-term and long-term maintenance plan of the power grid is carried out according to a preset ground state power flow limit.

In some alternative embodiments, the method for acquiring the historical load values of the power grid includes the following operations.

Load data of at least one bus in the power grid at at least one of the historical moments is acquired.

Abnormal data in each load data of the at least one bus is filtered through a density clustering algorithm.

Normal load data of each bus is obtained, and an intersection set of historical moment sets corresponding to the normal load data of the buses is taken to obtain a sample time set, and when the sample time set is not an empty set, the load data set at each historical moment in the sample time set is taken as a historical load value at the corresponding historical moment.

Otherwise, an intersection set is taken for each two of the historical moment sets corresponding to the normal load data of the buses, to obtain at least one check intersection set, a union set is taken for one or more buses, each with less normal load data in each two of the buses corresponding to an empty one of at least one check intersection set, to obtain a check union set, the one or more buses in the check union set are removed from all buses in the power grid, and the sample time set is recalculated.

In some alternative embodiments, the density clustering algorithm is a Density-Based Spatial Clustering of Applications with Noise (DBSCAN) algorithm.

In some alternative embodiments, the clustering algorithm is a K-MEANS clustering algorithm, a K_MEANS++ clustering algorithm or a M_K_MEANS clustering algorithm.

In some alternative embodiments, the power grid operation mode model is updated according to the maintenance plan and open loop point information by using a full wiring approach, to obtain a future-state power grid operation mode model, which includes the following operations.

Based on the power grid operation mode model at the target historical moment, all unconnected power grid equipment is connected to the power grid according to the shortest access path through topology analysis by adopting a breadth-first traversal approach; and maintenance equipment is removed from the power grid according to the maintenance plan, and open loop point equipment is disconnected according to the open loop point information for updating the power grid operation mode model, to obtain the future-state power grid operation mode model.

In some alternative embodiments, the operation that ground state power flow data of the power grid are calculated based on the future-state power grid operation mode model includes: ground state power flow data of the power grid are calculated through a PQ decomposition method based on the future-state power grid operation mode model.

In some alternative embodiments, the method further includes at least one of the following operations.

N−1 data of the power grid is calculated based on the future-state power grid operation mode model, and safety check on the medium-term and long-term maintenance plan of the power grid is carried out according to the N−1 data of the power grid and a preset N−1 data limit.

N−2 data of the power grid is calculated based on the future-state power grid operation mode model, and safety check on the medium-term and long-term maintenance plan of the power grid is carried out according to the N−2 data of the power grid and a preset N−2 data limit.

Fault group data of the power grid is calculated based on the future-state power grid operation mode model; and safety check on the medium-term and long-term maintenance plan of the power grid is carried out according to the fault group data of the power grid and a preset fault group data limit.

Same-rod equipment data of the power grid is calculated based on the future-state power grid operation mode model; and safety check on the medium-term and long-term maintenance plan of the power grid is carried out according to the same-rod equipment data of the power grid and a preset same-rod equipment data limit.

Section data of the power grid is calculated based on the future-state power grid operation mode model; and safety check on the medium-term and long-term maintenance plan of the power grid is carried out according to the section data of the power grid and a preset section data limit.

The embodiments of the disclosure further provide a system for checking a medium-term and long-term maintenance plan of a power grid, which may include a data acquisition module, a clustering module, an operation mode model determining module and a check module.

The data acquisition module is configured to acquire a predicted load value and historical load values of a power grid.

The clustering module is configured to cluster the predicted load value and the historical load values through a clustering algorithm, and select a historical moment at which a historical load value is in a same cluster as the predicted load value and has a largest load value among the historical load values as a target historical moment.

The operation mode model determining module is configured to acquire a power grid operation mode model at the target historical moment, and update the power grid operation mode model according to the maintenance plan and open loop point information by using a full wiring approach to obtain a future-state power grid operation mode model.

The check module is configured to calculate ground state power flow data of the power grid based on the future-state power grid operation mode model, and carry out safety check on the medium-term and long-term maintenance plan of the power grid according to a preset ground state power flow limit.

The embodiments of the disclosure further provide a computer device, which includes a memory, a processor and a computer program which is stored in the memory and running on the processor, and when executing the computer program, the processor implements the steps of the method for checking a medium-term and long-term maintenance plan of a power grid.

The embodiments of the disclosure further provide a computer readable storage medium, which stores a computer program thereon; and the computer program implements, when being executed by a processor, the steps of for checking a medium-term and long-term maintenance plan of a power grid.

According to the method and the system for checking the medium-term and long-term maintenance plan of the power grid, the device and the storage medium of the embodiments of the disclosure, the predicted load value and the historical load values of the power grid are acquired, the predicted load value and the historical load values are clustered through the clustering algorithm, a historical moment at which a historical load value is in a same cluster as the predicted load value and has a largest load value among the historical load values is selected as the target historical moment, on the basis of the power grid operation mode model of the historical moment, the power grid operation mode model is updated according to the maintenance plan and open loop point information by using a full wiring approach based thereon to obtain a future-state power grid operation mode model for safety check, ground state power flow data of the power grid are calculated based on the future-state power grid operation mode model, safety check on the medium-term and long-term maintenance plan of the power grid is carried out according to a preset ground state power flow limit. In this way, the automatic safety check of the medium-term and long-term maintenance plan of the power grid is realized, which requires little human intervention, human participation is needed merely in updating the power grid operation mode model, and thus the method has a high general applicability and little maintenance workload. Meanwhile, it merely needs load data of the buses, the amount of data to be predicted is small, and thus has a high implementability.

### BRIEF DESCRIPTION OF THE DRAWINGS

FIG. 1 is a flowchart schematic diagram of a method for checking a medium-term and long-term maintenance plan of a power grid according to embodiments of the disclosure.

FIG. 2 is a preprocessing flowchart schematic diagram of a load data of a historical moment according to the embodiments of the disclosure.

FIG. 3 is a diagram of a system for checking a medium-term and long-term maintenance plan of a power grid according to the embodiments of the disclosure.

### DETAILED DESCRIPTION

In order to enable those skilled in the art to better understand the solution of the disclosure, the technical solution in embodiments of the disclosure will be described clearly and completely in conjunction with the drawings in the embodiments of the disclosure. Obviously, the described embodiments are a part of, but not all of the embodiments of the disclosure. Based on the embodiments in the disclosure, all other embodiments obtained by those of ordinary skill in the art without creative work shall fall within the protection scope of the disclosure.

It is to be noted that the terms “first”, “second”, and the like in the specification and claims of the disclosure and in the above drawings are used to distinguish similar targets and unnecessarily to describe a specific sequence or sequential order. It will be appreciated that such data may be interchangeable where appropriate, so that the embodiments of the disclosure described herein can be implemented in a sequence except for those illustrated or described herein. In addition, the terms “include” and “having”, as well as any variations thereof, are intended to cover a non-exclusive inclusion, for example, a process, a method, a system, a product, or an apparatus that includes a series of steps or elements is not necessarily limited to those expressly listed steps or elements, but may include other steps or elements not expressly listed or inherent to such process, method, product, or apparatus.

Aiming at the problem in the background, the current public or commonly used treatment method in the industry is as follows: in a multi-time scale coordinated maintenance plan optimization method, first, an annual maintenance plan optimization model is established and solved, an annual maintenance plan is obtained after safety check, monthly decomposition is carried out; then a monthly maintenance plan optimization mode is established and solved, a monthly maintenance plan is obtained after safety check and weekly decomposition is carried out; safety check is carried out on a weekly maintenance plan, and an optimized maintenance plan with multi-time scales including annual maintenance plan, and the multi-time scale coordinated maintenance plan optimization plan including the annual maintenance plan, the monthly maintenance plan and the weekly maintenance plan is obtained. The embodiments of the disclosure realize the coupling and coordination of multi-time scale maintenance plans, considers the annual maintenance balance and new maintenance requirements, and ensures that the prepared maintenance plan meets the safe and stable operation requirements of the power system through section safety check, thus providing an effective tool for the rational formulation of the maintenance plan.

However, the above method does not fully explain the optimization part of the medium-term and long-term maintenance plan, and how to obtain the boundary required for annual and monthly check is still an unsolved problem, and how to realize the specific check is still unclear. Therefore, the effect of the method in practical application is not satisfactory. Based thereon, a method for checking a medium-term and long-term maintenance plan of a power grid of the embodiments of the disclosure can well solve the problems, specifically as follows.

The embodiments of the disclosure will be further described in detail below in conjunction with the drawings.

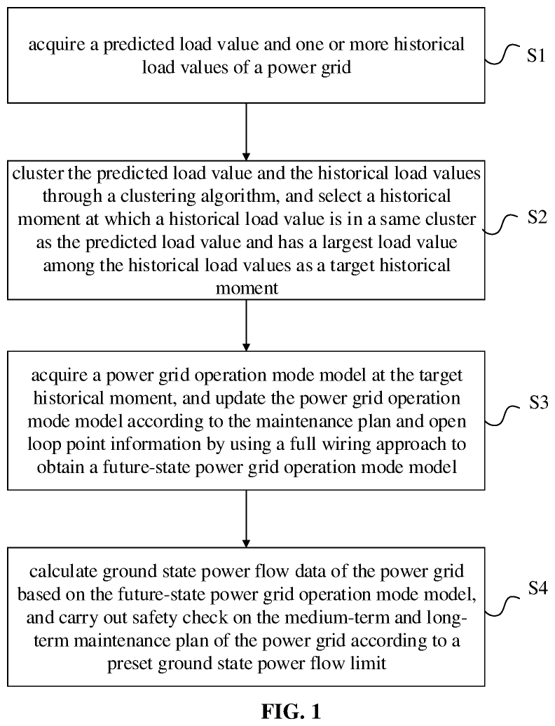

Referring to FIG. 1, in an alternative embodiment of the disclosure, a method for checking a medium-term and long-term maintenance plan of a power grid is provided, a predicted load value and historical load values of each bus are taken as original input data, by using a clustering algorithm, a future predicted load value of the bus is matched with a historical power grid operation mode model, a power grid operation mode model with the largest system load in the matched cluster is selected, full wiring and open loop point processing is carried out on the power grid operation mode model, the state of maintenance equipment is superimposed, and finally, power flow calculation safety check is carried out, so that safety check of the medium-term and long-term power grid maintenance plan is realized, and the maintenance plan is obtained and optimized according to a safety check result. For the method for checking a medium-term and long-term maintenance plan of a power grid, it requires little human intervention, human participation is needed merely in updating the power grid operation mode model, and thus the method has a high general applicability and little maintenance workload. Meanwhile, it merely needs load data of the buses, the amount of data to be predicted is small, and thus has a high implementability. Specifically, the method for checking a medium-term and long-term maintenance plan of a power grid includes the following steps.

S1, a predicted load value and historical load values of a power grid are acquired.

Exemplarily, the predicted load value of the power grid is predicted through the power grid operation mode model, sampling data and a future-state operation plan. The predicted load value may refer to a set in which elements are load data of each bus.

Exemplarily, one or more historical load values of a power grid are acquired, the value may be directly obtained from historical records of a dispatching system of the power grid.

In some alternative embodiments, based on the accuracy of the data, the following method is provided to preprocess the original historical load value to ensure the accuracy of the data.

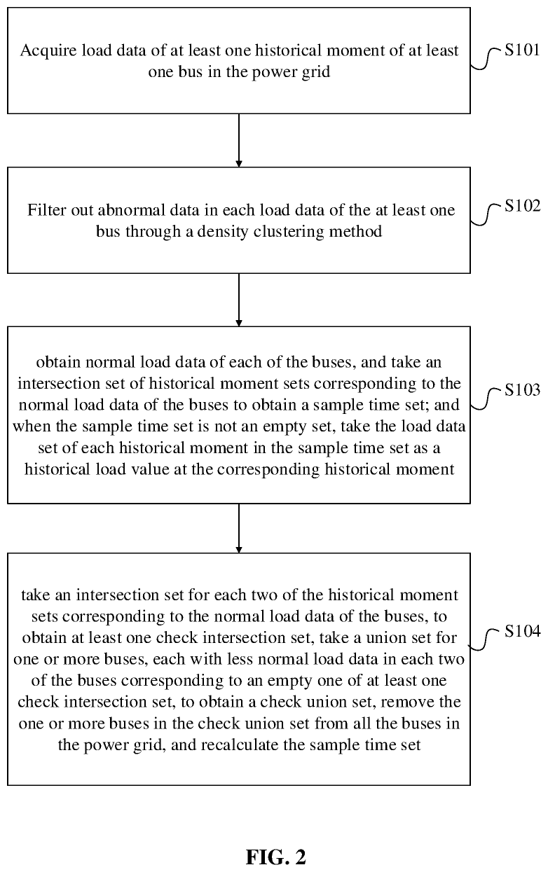

Alternatively, referring to FIG. 2, the preprocessing includes the following steps.

At S101, load data of at least one bus in the power grid at at least one of the historical moments is acquired.

At S102, abnormal data in the load data of the at least one bus is filtered out through a density clustering algorithm.

In the embodiment, according to the predicted number of bus names in the future, for each bus, the load data of the buses at all historical moments are divided into corresponding samples according to names, and if there is no corresponding bus at any historical moment, 0 is taken as the corresponding negative data. Exemplarily, each sample may be filtered by using a DBSCAN algorithm.

The DBSCAN algorithm is a clustering algorithm based on density. Different from division and hierarchical clustering algorithms, it defines clusters as the largest set of points connected by density, which can divide regions with high enough density into clusters and find clusters with any shapes in noisy spatial databases. Several definitions in DBSCAN: E neighborhood: an area within the radius E of a given object is called the E neighborhood of the object; core object: if the number of sample points in the E neighborhood of the given object is greater than or equal to MinPts (MinPts is the minimum number), the object is called a core object.

Based on the analysis of historical operation data of the power grid, the magnitude of E and magnitude of MinPts are set empirically, and the filtering out of abnormal data in load data of each bus is realized.

At S103, normal load data of each bus is obtained, and an intersection set of historical moment sets corresponding to the normal load data of the buses is taken to obtain a sample time set, and when the sample time set is not an empty set, a load data set at each historical moment in the sample time set is taken as a historical load value at the corresponding historical moment, which is taken as sample input of the clustering algorithm.

At S104, otherwise, namely, when the sample time set is an empty set, normal load data of each bus is obtained, an intersection set is taken for each two of the historical moment sets corresponding to the normal load data of the buses, to obtain at least one check intersection set, a union set is taken for one or more buses, each with less normal load data in each two of the buses corresponding to an empty one of at least one check intersection set, to obtain a check union set, the one or more buses in the check union set are removed from all the buses in the power grid, and the sample time set is recalculated.

When the normal load data in two buses corresponding to a check intersection set which is an empty set are the same, a union set is taken for the two buses.

At S2, the predicted load value and the historical load values are clustered through a clustering algorithm, and a historical moment at which a historical load value is in a same cluster as the predicted load value and has a largest load value among the historical load values is selected as a target historical moment.

Exemplarily, in the embodiment, the predicted load value and at least one historical load value may be clustered through a K-MEANS clustering algorithm. The K-MEANS clustering algorithm is an iterative solution clustering analysis algorithm, which includes the steps that: data are pre-divided into K groups, K objects are randomly selected as initial clustering centers, the distance between each object and each seed clustering center is calculated, and each object is allocated to its nearest clustering center. The clustering center and the object assigned thereto represent a cluster. The clustering center of the cluster is recalculated according to the existing object in the cluster when each sample is assigned. This process is repeated until certain termination condition is met, i.e., no (or a minimum number of) objects are reassigned to different clusters, that no (or a minimum number of) clustering centers change again, and a squared error sum is minimal locally.

Alternatively, the predicted load value and the historical load value may also be clustered by using a K_MEANS++ clustering algorithm or an M_K_MEANS clustering algorithm, which can achieve similar effects, but the performance and the result are different under different conditions.

The predicted load value and a plurality of historical load values are divided into a plurality of clusters through clustering analysis of the K-MEANS clustering algorithm, and a historical moment at which a historical load value is in a same cluster as the predicted load value and has a largest load value among the historical load values is selected as a target historical moment, for obtaining the historical moment closest to the power grid operation mode of the future state.

At S3, a power grid operation mode model at the target historical moment is acquired, and the power grid operation mode model is updated according to the maintenance plan and open loop point information by using a full wiring approach to obtain a future-state power grid operation mode model.

The power grid operation mode refers to the method and form of operation of power grid equipment. In the power grid, in order to ensure that the system operates safely, economically and reasonably or meet the requirements of maintenance work, the operation mode of the system needs to be changed frequently, which would correspondingly cause change of system parameters.

Specifically, a power grid operation mode model at the target historical moment is acquired to serve as the basis of the power grid operation mode model of the future state, on the basis, the power grid operation mode model is updated according to the maintenance plan and open loop point information by using a full wiring approach, and the updating steps include full wiring and superimposing maintenance equipment to disconnect an open loop point. The step determines the basis of the power grid operation mode of the future state required by establishment of the safety check and basic data for carrying out safety check of the maintenance plan.

Optionally, full wiring refers to that, based on the power grid operation mode model at the target historical moment, all unconnected power grid equipment is connected to the power grid according to the shortest access path through topology analysis by adopting a breadth-first traversal approach. Specifically, the unconnected power grid equipment is connected to the power grid in a mode of switching on a switch, and the unconnected power grid equipment is connected to the power grid according to the shortest access path through topology analysis by adopting a breadth-first traversal approach. The step aims to remove the influence caused by use of a historical maintenance plan contained in historical power grid equipment state data, on the premise of keeping the original power grid operation mode as much as possible.

Superimposing maintenance equipment refers to that: the maintenance equipment is removed from the power grid according to the maintenance plan for updating the power grid operation mode model to obtain the future-state power grid operation mode model. Specifically, the maintenance equipment is removed according to the maintenance plan, and then the state of the maintenance equipment is set as shutdown through a switch for preparing for the next step of power flow calculation.

Disconnecting an open loop point refers to that equipment in the power grid at the open loop point is disconnected according to the open loop point information.

At S4, ground state power flow data of the power grid are calculated based on the future-state power grid operation mode model, and safety check on the medium-term and long-term maintenance plan of the power grid is carried out according to a preset ground state power flow limit.

Alternatively, the operation that the ground state power flow data of the power grid are calculated specifically includes: the ground state power flow data of the power grid are calculated through a PQ decomposition method based on the future-state power grid operation mode model. The PQ decomposition method is a method for calculating the power flow of the power system, has a high calculation speed, occupies small memory and has wide applications. The PQ decomposition method, also known as the fast decoupling algorithm, is derived from the polar coordinate form of Newton-Raphson method. The basic idea is to express a node power as a polar coordinate equation of a voltage vector, grasp the main contradiction, take the active power error as the basis for correcting the voltage vector angle, take the reactive power error as the basis for correcting the voltage amplitude, and iterate active power and reactive power separately to calculate the ground state power flow data of the power grid.

At the beginning of establishment of the power grid, each bus has a ground state power flow limit, and these ground state power flow limits of the buses of the power grid are obtained. The safety check of the maintenance plan is carried out based on the calculated ground state power flow data of the power grid. When the calculated ground state power flow data of the power grid do not exceed the corresponding ground state power flow limit, it indicates that the safety check of the maintenance plan passes. Otherwise, it indicates that the safety check of the maintenance plan fails, and the maintenance plan needs to be optimized according to the result of the safety check.

In some alternative embodiments, besides the safety check of the ground state power flow data, at least one of the following methods may be carried out according to actual needs: N−1 data of the power grid is calculated based on the future-state power grid operation mode model, and safety check on the medium-term and long-term maintenance plan of the power grid is carried out according to the N−1 data of the power grid and a preset N−1 data limit; N−2 data of the power grid is calculated based on the future-state power grid operation mode model, and safety check on the medium-term and long-term maintenance plan of the power grid is carried out according to the N−2 data of the power grid and a preset N−2 data limit; fault group data of the power grid is calculated based on the future-state power grid operation mode model; safety check on the medium-term and long-term maintenance plan of the power grid is carried out according to the fault group data of the power grid and a preset fault group data limit; same-rod equipment data of the power grid is calculated based on the future-state power grid operation mode model; safety check on the medium-term and long-term maintenance plan of the power grid is carried out according to the same-rod equipment data of the power grid and a preset same-rod equipment data limit; section data of the power grid is calculated based on the future-state power grid operation mode model; and safety check on the medium-term and long-term maintenance plan of the power grid is carried out according to the section data of the power grid and a preset section data limit.

Safety adjustment is carried out on the maintenance plan according to the results of safety check, namely, after optimization, the steps of superposing maintenance equipment, power flow calculation and safety check may be repeated to verify the optimized maintenance plan.

In conclusion, according to the method for checking the medium-term and long-term maintenance plan of the power grid of the embodiment of the disclosure, the predicted load value and the historical load values of the power grid are acquired, the predicted load value and a plurality of historical load values are clustered based on the clustering algorithm, a historical moment at which a historical load value is in a same cluster as the predicted load value and has a largest load value among the historical load values is selected as the target historical moment, on the basis of the power grid operation mode model of the historical moment, the power grid operation mode model is updated according to the maintenance plan and open loop point information by using a full wiring approach based thereon to obtain a future-state power grid operation mode model for safety check, ground state power flow data of the power grid are calculated based on the future-state power grid operation mode model, safety check on the medium-term and long-term maintenance plan of the power grid is carried out according to a preset ground state power flow limit, the automatic safety check of the medium-term and long-term maintenance plan of the power grid is realized, the required human intervention is little, human participation is needed only in open loop point arrangement, universality is available, and the maintenance workload is little; meanwhile, the required predicated data is little, only the load value of the bus is needed, and the feasibility is higher.

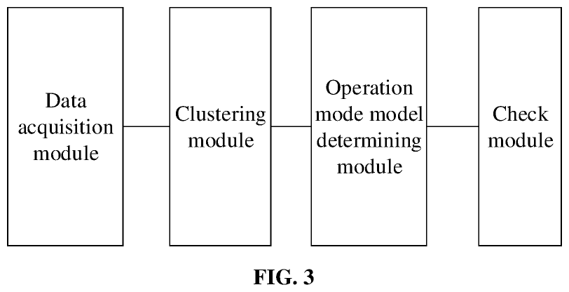

Referring to FIG. 3, in still another embodiment of the disclosure, a system for checking a medium-term and long-term maintenance plan of a power grid is provided, for realizing the above method for checking the medium-term and long-term maintenance plan of the power grid, specifically, the system for checking the medium-term and long-term maintenance plan of the power grid includes a data acquisition module, a clustering module, an operation mode model determining module and a check module.

The data acquisition module is configured to acquire a predicted load value and historical load values of a power grid; the clustering module is configured to cluster the predicted load value and the historical load values through a clustering algorithm, and select a historical moment at which a historical load value is in a same cluster as the predicted load value and has a largest load value among the historical load values as a target historical moment; the operation mode model determining module is configured to acquire a power grid operation mode model at the target historical moment, and update the power grid operation mode model according to the maintenance plan and open loop point information by using a full wiring approach to obtain a future-state power grid operation mode model; the check module is configured to calculate ground state power flow data of the power grid based on the future-state power grid operation mode model, and carry out safety check on the medium-term and long-term maintenance plan of the power grid according to a preset ground state power flow limit.

In some alternative embodiments, the data acquisition module is configured to acquire the load data of at least one bus in the power grid at at least one of the historical moments; filter abnormal data in each load data of the at least one bus through a density clustering algorithm; obtain normal load data of each bus, and take an intersection set of historical moment sets corresponding to the normal load data of each bus to obtain a sample time set, and when the sample time set is not an empty set, take the load data set of each historical moment in the sample time set as a historical load value at the corresponding historical moment; or when the sample time set is an empty set, take an intersection set for each two of the historical moment sets corresponding to the normal load data of the buses, to obtain at least one check intersection set, take a union set for one or more buses, each with less normal load data in each two of the buses corresponding to an empty one of at least one check intersection set, to obtain a check union set, remove the one or more buses in the check union set from all the buses in the power grid, and recalculate the sample time set.

In some alternative embodiments, the density clustering algorithm is a DB SCAN algorithm.

In some alternative embodiments, the clustering algorithm is a K-MEANS clustering algorithm, a K_MEANS++ clustering algorithm or a M_K_MEANS clustering algorithm.

In some alternative embodiments, the operation mode model determining module is configured to, connect, based on the power grid operation mode model at the target historical moment, all unconnected power grid equipment to the power grid according to the shortest access path through topology analysis by adopting a breadth-first traversal approach; remove maintenance equipment from the power grid according to the maintenance plan, and disconnect open loop point equipment according to the open loop point information, and update the power grid operation mode model to obtain the future-state power grid operation mode model.

In some alternative embodiments, the check module is configured to calculate ground state power flow data of the power grid through a PQ decomposition method based on the future-state power grid operation mode model.

In some alternative embodiments, the check module is further configured to carry out at least one of the following operations: calculate N−1 data of the power grid based on the future-state power grid operation mode model, and carry out safety check on the medium-term and long-term maintenance plan of the power grid according to the N−1 data of the power grid and a preset N−1 data limit;
calculate N−2 data of the power grid based on the future-state power grid operation mode model, and carry out safety check on the medium-term and long-term maintenance plan of the power grid according to the N−2 data of the power grid and a preset N−2 data limit;
calculate fault group data of the power grid based on the future-state power grid operation mode model; and carry out safety check on the medium-term and long-term maintenance plan of the power grid according to the fault group data of the power grid and a preset fault group data limit;
calculate same-rod equipment data of the power grid based on the future-state power grid operation mode model; and carry out safety check on the medium-term and long-term maintenance plan of the power grid according to the same-rod equipment data of the power grid and a preset same-rod equipment data limit; and calculate section data of the power grid based on the future-state power grid
operation mode model; and carry out safety check on the medium-term and long-term maintenance plan of the power grid according to the section data of the power grid and a preset section data limit.

In yet another embodiment of the disclosure, a computer device is provided, which includes a processor and a memory, the memory is configured to store a computer program, the computer program includes a program instruction, and the processor is configured to execute the program instruction stored in the computer storage medium. The processor may be a Central Processing Unit (CPU), and may further be other universal processors, a Digital Signal Processor (DSP), an Application Specific Integrated Circuit (ASIC) and a Field Programmable Gate Array (FPGA) or other programmable logic devices, discrete gates or transistor logic devices, and discrete hardware component, etc, it is the computing core and control core of the computer device, which is suitable for implementing one or more instructions, in particular for loading and executing one or more instructions so as to implement corresponding method flow or corresponding function; the processor of the embodiment of the disclosure may be used for operation of the method for checking the medium-term and long-term maintenance plan of the power grid, at least including: the predicted load value and the historical load values of the power grid are acquired, the predicted load value and the historical load value are clustered through the clustering algorithm, and the historical moment at which a historical load value is in a same cluster as the predicted load value and has the largest load value among the historical load values is selected as the target historical moment; the power grid operation mode model at the target historical moment is acquired, the power grid operation mode model is updated according to the maintenance plan and open loop point information by using a full wiring approach to obtain a future-state power grid operation mode model; ground state power flow data of the power grid are calculated based on the future-state power grid operation mode model, and safety check on the medium-term and long-term maintenance plan of the power grid is carried out according to a preset ground state power flow limit.

In yet another embodiment of the disclosure, a storage medium is provided, in particular to a computer-readable storage medium (Memory), which is a memory device in a terminal device for storing programs and data. It may be understood that the computer-readable storage medium herein may include a built-in storage medium in the terminal device, and of course, may also include an extended storage medium supported by the terminal device. The computer-readable storage medium provides storage space, and the storage space stores the operating system of the terminal. In addition, one or more instructions suitable for being loaded and executed by the processor are stored in the storage space, and these instructions may be one or more computer programs (including program codes). It is to be noted that the computer-readable storage medium herein may be a high-speed Random Access Memory (RAM) memory, or a non-volatile memory (non-volatile memory), such as at least one disk memory.

One or more instructions stored in the computer-readable storage medium may be loaded and executed by the processor to implement the corresponding steps in the above embodiment related to the method for checking the medium-term and long-term maintenance plan of the power grid; one or more instructions in the computer-readable storage medium are loaded by the processor and execute at least the following steps: the predicted load value and the historical load values of the power grid are acquired, the predicted load value and the historical load values are clustered through the clustering algorithm, a historical moment at which a historical load value is in a same cluster as the predicted load value and has a largest load value among the historical load values is selected as the target historical moment; the power grid operation mode model at the target historical moment is acquired, the power grid operation mode model is updated according to the maintenance plan and open loop point information by using a full wiring approach to obtain a future-state power grid operation mode model; ground state power flow data of the power grid are calculated based on the future-state power grid operation mode model, and safety check on the medium-term and long-term maintenance plan of the power grid is carried out according to a preset ground state power flow limit.

Those skilled in the art should understand that the embodiments of the disclosure may be provided as methods, systems, or computer program products. Therefore, the disclosure may adopt the form of a complete hardware embodiment, a complete software embodiment, or an embodiment combining software and hardware. Moreover, the disclosure may adopt the form of a computer program product implemented on one or more computer-usable storage media (including but not limited to disk storage, Compact Disc Read-Only Memory (CD-ROM), optical storage, etc.) containing computer-usable program codes.

The disclosure is described with reference to flowcharts and/or block diagrams of the method, the device (system) and the computer program product according to the embodiments of the disclosure. It should be understood that each flow and/or block in the flowcharts and/or the block diagrams and a combination of the flows and/or the blocks in the flowcharts and/or the block diagrams can be realized by computer program instructions. These computer program instructions can be provided for a general computer, a dedicated computer, an embedded processor or processors of other programmable data processing devices to generate a machine, so that an apparatus for realizing functions assigned in one or more flows of the flowcharts and/or one or more blocks of the block diagrams is generated via instructions executed by the computers or the processors of the other programmable data processing devices.

These computer program instructions can also be stored in a computer readable memory capable of guiding the computers or the other programmable data processing devices to work in a specific mode, so that a manufactured product including an instruction apparatus is generated via the instructions stored in the computer readable memory, and the instruction apparatus realizes the functions assigned in one or more flows of the flowcharts and/or one or more blocks of the block diagrams.

These computer program instructions can also be loaded to the computers or the other programmable data processing devices, so that processing realized by the computers is generated by executing a series of operation steps on the computers or the other programmable devices, and therefore the instructions executed on the computers or the other programmable devices provide a step of realizing the functions assigned in one or more flows of the flowcharts and/or one or more blocks of the block diagrams.

Finally, it is to be noted that the above embodiments are only used to illustrate the technical solutions of the disclosure and not to limit them. Although the disclosure has been described in detail with reference to the above embodiments, those of ordinary skill in the art should understand that: modifications or equivalent replacements are made to the specific embodiments of, and any modifications or equivalent replacements that do not depart from the spirit and scope of the disclosure shall be covered by the protection scope of the claims of the disclosure.

1. A method for checking a medium-term and long-term maintenance plan of a power grid, comprising:
acquiring a predicted load value and one or more historical load values of the power grid;
clustering the predicted load value and the historical load values through a clustering algorithm, and selecting a historical moment at which a historical load value is in a same cluster as the predicted load value and has a largest load value among the historical load values as a target historical moment;
acquiring a power grid operation mode model at the target historical moment, and updating the power grid operation mode model according to the maintenance plan and open loop point information by using a full wiring approach, to obtain a future-state power grid operation mode model;
calculating ground state power flow data of the power grid based on the future-state power grid operation mode model, and carrying out safety check on the medium-term and long-term maintenance plan of the power grid according to a preset ground state power flow limit.

2. The method of claim 1, wherein acquiring historical load values of a power grid comprises:
acquiring load data of one or more buses in the power grid at at least one of the historical moments;
filtering out abnormal data in each load data of the one or more buses through a density clustering algorithm;
obtaining normal load data of each of the buses, and taking an intersection set of historical moment sets corresponding to the normal load data of the buses to obtain a sample time set; and
when the sample time set is not an empty set, taking the load data set of each historical moment in the sample time set as a historical load value at the corresponding historical moment; or
when the sample time set is an empty set, taking an intersection set for each two of the historical moment sets corresponding to the normal load data of the buses, to obtain at least one check intersection set, taking a union set for one or more buses, each with less normal load data in each two of the buses corresponding to an empty one of at least one check intersection set, to obtain a check union set, removing the one or more buses in the check union set from all the buses in the power grid, and recalculating the sample time set.

3. The method of claim 2, wherein the density clustering algorithm is a Density-Based Spatial Clustering of Applications with Noise (DBSCAN) algorithm.

4. The method of claim 1, wherein the clustering algorithm is a K-MEANS clustering algorithm, a K_MEANS++ clustering algorithm or a M_K_MEANS clustering algorithm.

5. The method of claim 1, wherein updating the power grid operation mode model according to the maintenance plan and open loop point information by using a full wiring approach to obtain a future-state power grid operation mode model comprises:
connecting, based on the power grid operation mode model at the target historical moment, all unconnected power grid equipment to the power grid according to the shortest access path through topology analysis by adopting a breadth-first traversal approach; and removing maintenance equipment from the power grid according to the maintenance plan, disconnecting open loop point equipment according to the open loop point information, and updating the power grid operation mode model to obtain the future-state power grid operation mode model.

6. The method of claim 1, wherein calculating ground state power flow data of the power grid based on the future-state power grid operation mode model comprises:
calculating the ground state power flow data of the power grid through a PQ decomposition method based on the future-state power grid operation mode model.

7. The method of claim 1, wherein the method further comprises at least one of the following:
calculating N−1 data of the power grid based on the future-state power grid operation mode model, and carrying out safety check on the medium-term and long-term maintenance plan of the power grid according to the N−1 data of the power grid and a preset N−1 data limit;
calculating N−2 data of the power grid based on the future-state power grid operation mode model, and carrying out safety check on the medium-term and long-term maintenance plan of the power grid according to the N−2 data of the power grid and a preset N−2 data limit;
calculating fault group data of the power grid based on the future-state power grid operation mode model; and carrying out safety check on the medium-term and long-term maintenance plan of the power grid according to the fault group data of the power grid and a preset fault group data limit;
calculating same-rod equipment data of the power grid based on the future-state power grid operation mode model; and carrying out safety check on the medium-term and long-term maintenance plan of the power grid according to the same-rod equipment data of the power grid and a preset same-rod equipment data limit;
and calculating section data of the power grid based on the future-state power grid operation mode model; and carrying out safety check on the medium-term and long-term maintenance plan of the power grid according to the section data of the power grid and a preset section data limit.

8. (canceled)

9. A computer device, comprising a memory, a processor and a computer program which is stored in the memory and runnable on the processor, and when executing the computer program, the processor implements a method for checking a medium-term and long-term maintenance plan of the power grid, comprising:
acquiring a predicted load value and one or more historical load values of the power grid;
clustering the predicted load value and the historical load values through a clustering algorithm, and selecting a historical moment at which a historical load value is in a same cluster as the predicted load value and has a largest load value among the historical load values as a target historical moment;
acquiring a power grid operation mode model at the target historical moment, and updating the power grid operation mode model according to the maintenance plan and open loop point information by using a full wiring approach, to obtain a future-state power grid operation mode model;
calculating ground state power flow data of the power grid based on the future-state power grid operation mode model, and carrying out safety check on the medium-term and long-term maintenance plan of the power grid according to a preset ground state power flow limit.

10. A non-transitory computer readable storage medium, storing a computer program thereon, and the computer program implements, when being executed by a processor, a method for checking a medium-term and long-term maintenance plan of a power grid, comprising:
acquiring a predicted load value and one or more historical load values of the power grid;
clustering the predicted load value and the historical load values through a clustering algorithm, and selecting a historical moment at which a historical load value is in a same cluster as the predicted load value and has a largest load value among the historical load values as a target historical moment;
acquiring a power grid operation mode model at the target historical moment, and updating the power grid operation mode model according to the maintenance plan and open loop point information by using a full wiring approach, to obtain a future-state power grid operation mode model;
calculating ground state power flow data of the power grid based on the future-state power grid operation mode model, and carrying out safety check on the medium-term and long-term maintenance plan of the power grid according to a preset ground state power flow limit.

11. The computer device of claim 9, wherein acquiring historical load values of a power grid comprises:
acquiring load data of one or more buses in the power grid at at least one of the historical moments;
filtering out abnormal data in each load data of the one or more buses through a density clustering algorithm;
obtaining normal load data of each of the buses, and taking an intersection set of historical moment sets corresponding to the normal load data of the buses to obtain a sample time set; and
when the sample time set is not an empty set, taking the load data set of each historical moment in the sample time set as a historical load value at the corresponding historical moment; or
when the sample time set is an empty set, taking an intersection set for each two of the historical moment sets corresponding to the normal load data of the buses, to obtain at least one check intersection set, taking a union set for one or more buses, each with less normal load data in each two of the buses corresponding to an empty one of at least one check intersection set, to obtain a check union set, removing the one or more buses in the check union set from all the buses in the power grid, and recalculating the sample time set.

12. The computer device of claim 11, wherein the density clustering algorithm is a Density-Based Spatial Clustering of Applications with Noise (DBSCAN) algorithm.

13. The computer device of claim 9, wherein the clustering algorithm is a K-MEANS clustering algorithm, a K_MEANS++ clustering algorithm or a M_K_MEANS clustering algorithm.

14. The computer device of claim 9, wherein updating the power grid operation mode model according to the maintenance plan and open loop point information by using a full wiring approach to obtain a future-state power grid operation mode model comprises:
connecting, based on the power grid operation mode model at the target historical moment, all unconnected power grid equipment to the power grid according to the shortest access path through topology analysis by adopting a breadth-first traversal approach; and removing maintenance equipment from the power grid according to the maintenance plan, disconnecting open loop point equipment according to the open loop point information, and updating the power grid operation mode model to obtain the future-state power grid operation mode model.

15. The computer device of claim 9, wherein calculating ground state power flow data of the power grid based on the future-state power grid operation mode model comprises:
calculating the ground state power flow data of the power grid through a PQ decomposition method based on the future-state power grid operation mode model.

16. The computer device of claim 9, wherein the method further comprises at least one of the following:
calculating N−1 data of the power grid based on the future-state power grid operation mode model, and carrying out safety check on the medium-term and long-term maintenance plan of the power grid according to the N−1 data of the power grid and a preset N−1 data limit;
calculating N−2 data of the power grid based on the future-state power grid operation mode model, and carrying out safety check on the medium-term and long-term maintenance plan of the power grid according to the N−2 data of the power grid and a preset N−2 data limit;
calculating fault group data of the power grid based on the future-state power grid operation mode model; and carrying out safety check on the medium-term and long-term maintenance plan of the power grid according to the fault group data of the power grid and a preset fault group data limit;
calculating same-rod equipment data of the power grid based on the future-state power grid operation mode model; and carrying out safety check on the medium-term and long-term maintenance plan of the power grid according to the same-rod equipment data of the power grid and a preset same-rod equipment data limit;
and calculating section data of the power grid based on the future-state power grid operation mode model; and carrying out safety check on the medium-term and long-term maintenance plan of the power grid according to the section data of the power grid and a preset section data limit.

17. The non-transitory computer readable storage medium of claim 10, wherein acquiring historical load values of a power grid comprises:
acquiring load data of one or more buses in the power grid at at least one of the historical moments;
filtering out abnormal data in each load data of the one or more buses through a density clustering algorithm;
obtaining normal load data of each of the buses, and taking an intersection set of historical moment sets corresponding to the normal load data of the buses to obtain a sample time set; and
when the sample time set is not an empty set, taking the load data set of each historical moment in the sample time set as a historical load value at the corresponding historical moment; or
when the sample time set is an empty set, taking an intersection set for each two of the historical moment sets corresponding to the normal load data of the buses, to obtain at least one check intersection set, taking a union set for one or more buses, each with less normal load data in each two of the buses corresponding to an empty one of at least one check intersection set, to obtain a check union set, removing the one or more buses in the check union set from all the buses in the power grid, and recalculating the sample time set.

18. The non-transitory computer readable storage medium of claim 17, wherein the density clustering algorithm is a Density-Based Spatial Clustering of Applications with Noise (DBSCAN) algorithm.

19. The non-transitory computer readable storage medium of claim 10, wherein the clustering algorithm is a K-MEANS clustering algorithm, a K_MEANS++ clustering algorithm or a M_K_MEANS clustering algorithm.

20. The non-transitory computer readable storage medium of claim 10, wherein updating the power grid operation mode model according to the maintenance plan and open loop point information by using a full wiring approach to obtain a future-state power grid operation mode model comprises:
connecting, based on the power grid operation mode model at the target historical moment, all unconnected power grid equipment to the power grid according to the shortest access path through topology analysis by adopting a breadth-first traversal approach; and removing maintenance equipment from the power grid according to the maintenance plan, disconnecting open loop point equipment according to the open loop point information, and updating the power grid operation mode model to obtain the future-state power grid operation mode model.

21. The non-transitory computer readable storage medium of claim 10, wherein calculating ground state power flow data of the power grid based on the future-state power grid operation mode model comprises:
calculating the ground state power flow data of the power grid through a PQ decomposition method based on the future-state power grid operation mode model.
